(19) United States
(12) Patent Application Publication
(10) Pub. No.: US 2016/0003212 A1
(43) Pub. Date: Jan. 7, 2016

(54) Underwater Multi-Turbine Generator

(71) Applicant: Stephanie M. Holt, Parrottsville, TN (US)

(72) Inventor: Daniel Leonard, Pocatello, ID (US)

(21) Appl. No.: 14/324,271

(22) Filed: Jul. 7, 2014

(51) Int. Cl. F03B 13/10; F03B 3/06; F03B 11/02; F03B 3/04

(52) U.S. Cl. CPC F03B 13/10; F03B 3/04; F03B 3/06; F03B 11/02

(57) ABSTRACT

An underwater multi-generator turbine system is provided including an inlet funnel, a plurality of generator units, and a platform. The inlet funnel includes an inlet end and a narrower outlet end. Each of the plurality of generator units includes one or more turbine blades that are substantially aligned adjacent the narrower outlet end of the inlet funnel. The platform supports the inlet funnel and plurality of generator units. The inlet funnel receives fluid from a moving body of water in the inlet end and directs the fluid to the turbine blades of the plurality of generator units adjacent the narrower outlet end of the inlet funnel.

### FIELD

This disclosure relates to the field of underwater generator systems. More particularly, this disclosure relates to a multi-turbine underwater generator system for generating electricity in a moving body of water.

### BACKGROUND

Various devices have been created in attempts to capture tidal and other underwater currents to provide a source of alternative energy. Often devices that have been created to harness ocean currents require multiple units to be installed over a substantial area, frequently referred to as “farms.” These farm installations require multiple units spread over a substantial area to recover energy from the ocean current in multiple turbines generators. The multiple units require multiple inlets and installation sites, thereby increasing the cost and complexity of recovering energy from the ocean current.

In a typical turbine unit, if the turbine generator fails then the turbine unit ceases to produce power until the turbine unit is brought to the surface or otherwise repaired. This results in substantially lengthy periods of down time until the turbine unit may be repaired wherein no electricity is produced by the generator.

What is needed, therefore, is an underwater multi-turbine generator configured to efficiently capture ocean currents and generate energy from a plurality of turbine generators, and that is further configured to be substantially reliable and readily repairable.

### SUMMARY

The above and other needs are met by an underwater multi-turbine generator system. In a preferred embodiment, the multi-turbine generator system includes an inlet funnel including an inlet end and a narrower outlet end, a plurality of generator units, each of the plurality of generator units including one or more turbine blades, wherein the turbine blades of the plurality of generator are substantially aligned adjacent the narrower outlet end of the inlet funnel, and a platform for supporting the inlet funnel and plurality of generator units. The inlet funnel receives fluid from a moving body of water in the inlet end and directs the fluid to the turbine blades of the plurality of generator units adjacent the narrower outlet end of the inlet funnel.

In one embodiment, the platform is comprises a plurality of ballast tanks for varying a depth of the underwater multi-turbine generator system. In another embodiment, the multi-turbine generator system further includes one or more gyroscopes being in electrical communication with the plurality of ballast tanks for maintaining a position of the multi-turbine generator system.

In yet another embodiment the turbine blades of one or more of the plurality of turbine units are a first size and the turbine blades of one or more of the other plurality of turbines are a second and different size.

In one embodiment each of the plurality of generator units is substantially modular such that each of the plurality of generator units is removable independent of other generator units.

In another embodiment a pitch of the turbine blades of the plurality of generator units is adjustable.

In another aspect, embodiments of the disclosure provide an underwater multi-turbine generator system including an inlet funnel including an inlet end and a narrower outlet end, a plurality of generator units, each of the plurality of generator units including one or more turbine blades wherein the turbine blades of the plurality of generator are substantially aligned adjacent the narrower outlet end of the inlet funnel and wherein each of the plurality of generator units is substantially modular such that each of the plurality of generator units is removable independent of other generator units, a platform for supporting the inlet funnel and plurality of generator units, wherein the platform is comprises a plurality of ballast tanks for varying a depth of the underwater multi-turbine generator system, and one or more gyroscopes, the one or more gyroscopes being in electrical communication with the plurality of ballast tanks for maintaining a position of the multi-turbine generator system. The inlet funnel receives fluid from a moving body of water in the inlet end and directs the fluid to the turbine blades of the plurality of generator units adjacent the narrower outlet end of the inlet funnel.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a diagram of a multi-turbine generator unit according to one embodiment of the present disclosure;

FIGS. 2 and 3 illustrate an inlet funnel of a multi-turbine generator unit according to one embodiment of the present disclosure;

FIGS. 4-7 illustrate one or more generator units adjacent the inlet funnel according to one embodiment of the present disclosure; and

FIGS. 8 and 9 illustrate a platform of a multi-turbine generator unit according to one embodiment of the present disclosure.

### DETAILED DESCRIPTION

Various terms used herein are intended to have particular meanings Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

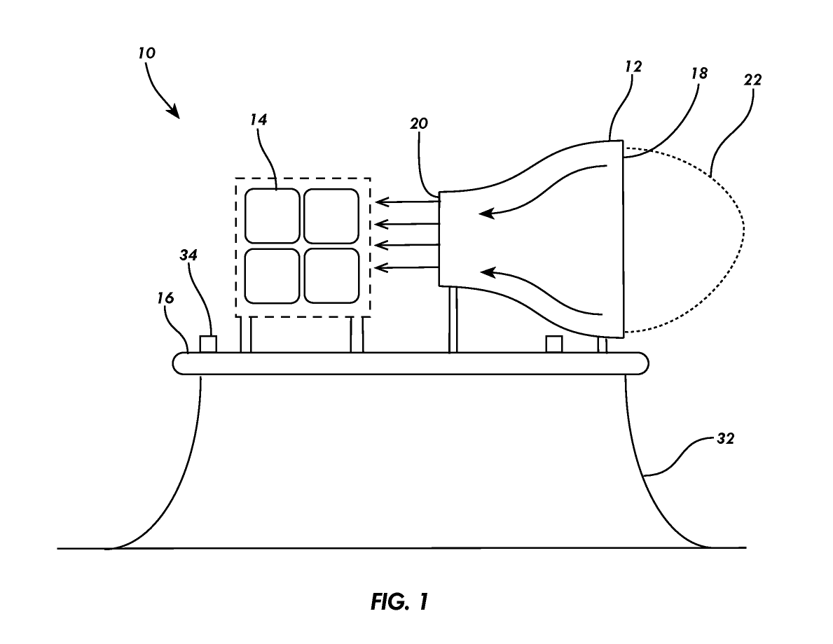

FIG. 1 shows a basic embodiment of a tidal current multi-turbine generator system 10. The multi-turbine generator system 10 includes multiple turbine generator units in communication with a single inlet and is deployed in a path of a sub-sea tide or current. The multi-turbine generator system 10 is configured to generate power from the sub-sea tide or current using the multiple turbine generator units. An inlet funnels the sub-sea tide or current to the multiple generator units to efficiently generate power from the sub-sea tide or current.

The multi-turbine generator system 10 includes an inlet funnel 12 and a plurality of generator units 14 in fluid communication with the inlet funnel 12. The inlet funnel 12 and plurality of generator units 14 are mounted on a platform 16. The platform 16 supports the generator system 10 at a desired submerged depth to maintain the inlet funnel 12 and plurality of generator units 14 in a path of the sub-sea current or tide and allows the depth of the system 10 to be adjusted based on changes to the sub-sea current or tide or for maintenance.

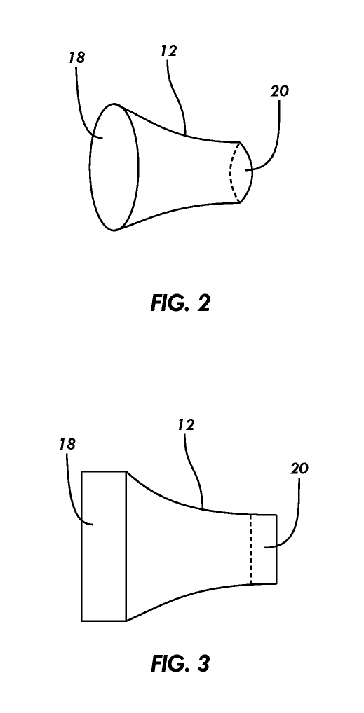

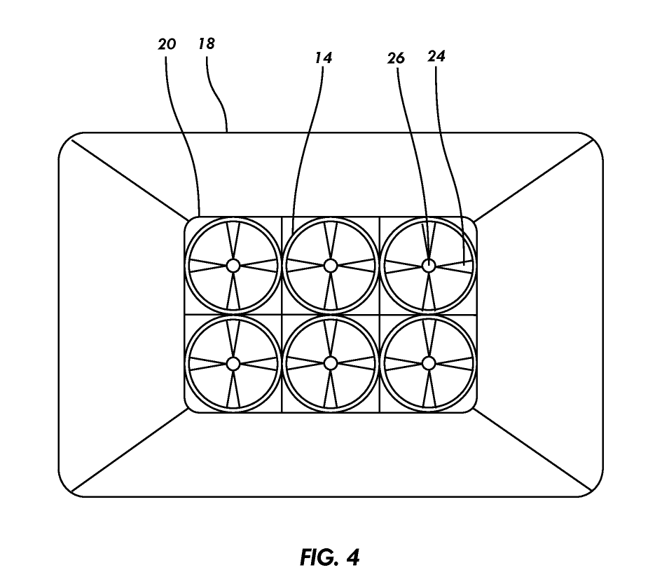

With further reference to FIG. 1, the inlet funnel 12 includes a inlet end 18 and a narrower outlet end 20. The inlet end 18 and outlet end 20 may be substantially circular in shape, as illustrated in FIG. 2. Alternatively, the inlet end 18 and outlet end 20 may be substantially rectangular in shape as illustrated in FIG. 3. The inlet funnel 12 is substantially tapered from the inlet end 18 to the outlet end 20.

The first inlet end 18 has a diameter of from about 30 feet to about 120 feet. The inlet funnel 12 may include a mesh screen 22 formed into a cone extending from the first inlet end 18 of the inlet funnel. The mesh screen 22 is preferably formed of a steel mesh sized to prevent trash, fish or other organisms from entering the inlet funnel 12 and generator system 10.

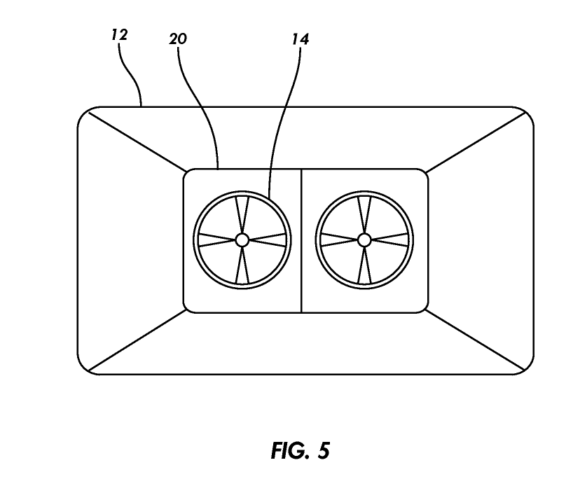

The multi-turbine generator system 10 is advantageously configured to capture a sub-sea current with the inlet funnel 12 and efficiently direct the current to a plurality of turbine generator units 14. Referring now to FIG. 4, the plurality of generator units 14 are positioned adjacent the narrower outlet end 20 of the inlet funnel 12. The generator units 14 include a plurality of turbine blades 24 secured to a turbine hub 26. The turbine blades 24 may be formed into one of several known blade profiles, such as a substantially curved shape or a substantially flat shape as illustrated in FIG. 4. Additionally, the turbine blades 24 may be pivotally secured to the turbine hub 26 such that a pitch angle of the turbine blades 24 may be adjusted.

The generator units 14 are configured to convert kinetic energy of fluid entering the inlet funnel 12 and convert that energy into electricity or other recoverable forms of energy. While turbine blades 24 and a turbine hub 26 are described above, it is also understood that the generator units 14 may comprise various other recovery configurations such as a vertical axis turbine or various other configurations for converting kinetic fluid energy into electricity.

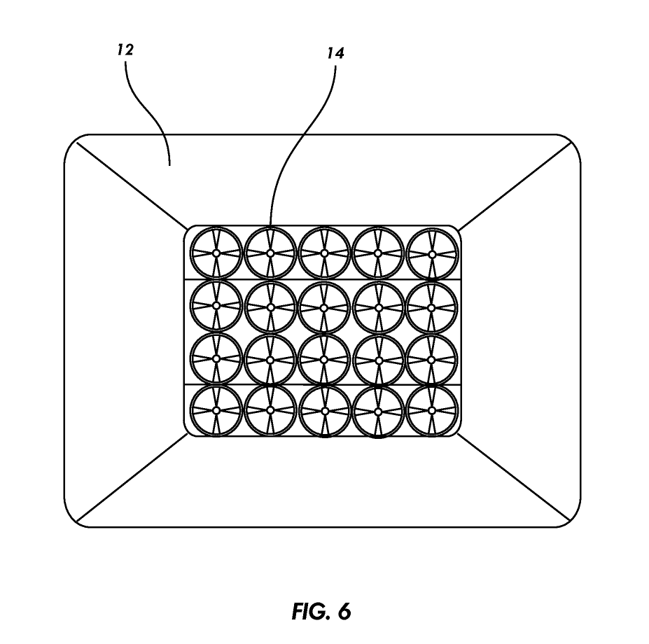

The configuration of the plurality of generator units 14 may depend on the number and size of generator units installed in the multi-turbine generator system 10 and the size of the narrower outlet end 20 of the funnel 12. FIGS. 5-7 illustrate various configurations of generator units adjacent the outlet end 20 of the funnel 12. For example, in the embodiment of FIG. 5 as few as two generator units 14 may be positioned adjacent the outlet end 20 of the funnel 12. Alternatively, as many as 20 or more generator units 14 may be installed adjacent the outlet end 20 of the funnel 12 as illustrated in FIG. 6.

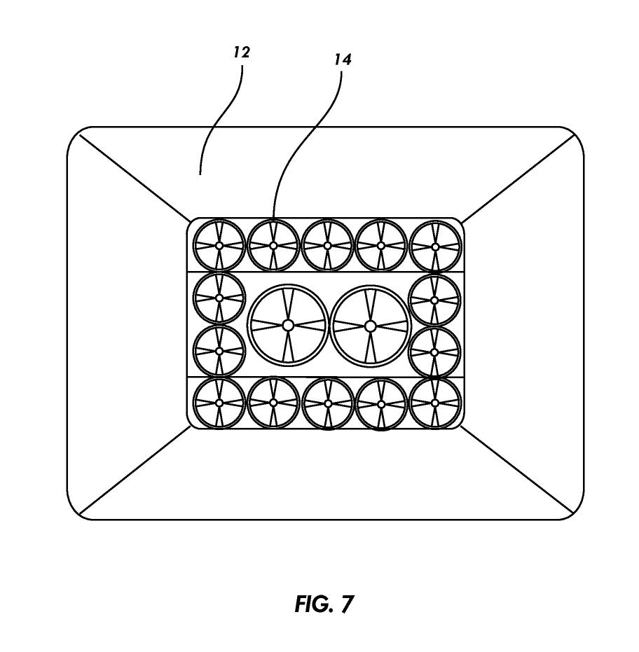

In another embodiment shown in FIG. 7, the size of the turbine blades 24 of the generator units may vary depending on the location of the generator unit 14 at the outlet end 20 of the funnel 12 such as by positioning smaller generator units 14 adjacent walls of the inlet 12 and one or more larger generator units towards a center of the inlet 12. Alternatively, larger generator units may be positioned adjacent walls of the inlet 12 while smaller generator units may be placed towards the center of the inlet 12. The position and size of the generator units may be configured to optimize the amount of energy recovered from fluid entering the inlet funnel 12.

Each of the plurality of generator units 14 configured to be substantially modular such that a generator unit 14 of the multi-turbine generator system 10 may be removed without affecting operation of the other generator units 14. For example, the turbine blades 24, turbine hub 26, and other generator components of the generator unit 14 may be enclosed within a housing such that the entire generator unit 14 may be removed or installed as a single component.

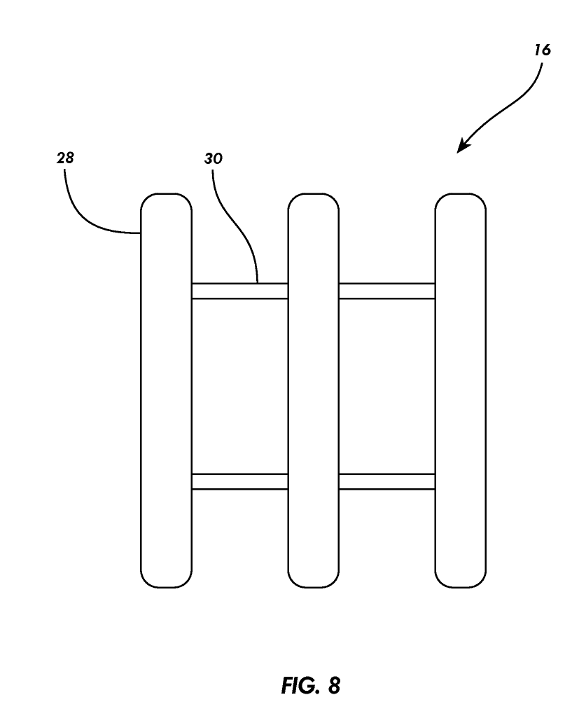

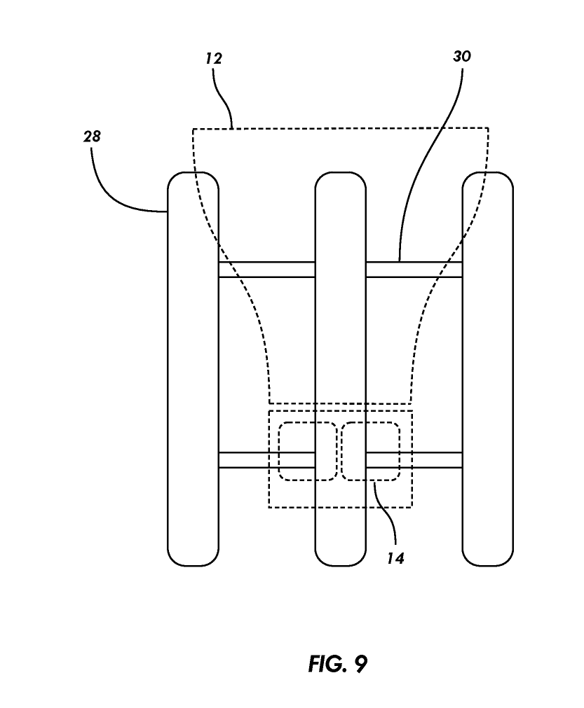

Referring again to FIG. 1, the multi-turbine generator system 10 includes a platform 16 for supporting the inlet funnel 12 and plurality of generator units 14. The platform is configured to support the inlet funnel 12, plurality of generator units 14 and various other components of the multi-turbine generator system 10. The platform 16 includes one or more ballast tanks for adjusting buoyancy of the platform and thereby allowing the platform 16 to be raised or lowered in a body of water. FIG. 8 illustrates one embodiment of a platform 16 including a plurality of elongate ballast tanks 28 positioned adjacent one another for supporting the components of the multi-turbine generator system. The plurality of elongate ballast tanks 28 are secured to one another with one or more frame cross-members 30. The ballast tanks 28 may be further subdivided into ballast sub-tanks for distributing ballast across different portions of the ballast tanks 28. The cross-members 30 and ballast tanks 28 support the inlet funnel 12 and plurality of generator units as shown in FIG. 9.

One or more tethers 32 (FIG. 1) are secured to the platform 16 for anchoring the generator system 10 to a floor of a body of water in which the generator system 10 is positioned. The tethers 32 may either maintain the generator system 10 at a desired height above the floor of the body of water or secure the generator system directly adjacent to the floor of the body of water.

While the platform preferably includes one or more ballast tanks 28 as described above, it is also understood that the platform may comprise a base or other structure suitable for supporting the inlet funnel 12 and plurality of generator units 14. For example, the platform may be formed of a pylon or other structure anchored to a floor of a body of water. Alternatively, the platform include a structure that floats or is secured at a surface of the body of water.

The generator system 10 includes a controller in electrical communication with one or more gyroscopes 34 and one or more pumps 36 secured to the platform 16 for maintaining a position of the generator system 10. The one or more gyroscopes 32 measure and maintain an orientation of the generator system and the pumps 34 are in communication with the plurality of ballast tanks 28 for adding or removing ballast from the generator system 10. The controller 34 may include, for example, a processor and a computer readable storage medium. The controller 34 may further be in electrical communication with the one or more generator units14.

The generator system 10 is preferably installed in a moving body of water such that the generator system 10 is submerged beneath a surface of the moving body of water. For example, in large-scale applications the generator system 10 is submerged in an ocean at a suitable location and depth where a substantially steady current exists. Alternatively, the generator system 10 may be installed in a river, creek, or other moving body of water such that the generator system 10 is substantially submerged within the moving body of water. The generator system 10 is submerged to a desired depth by flooding the plurality of ballast tanks 28. In some environments it may be desirable to submerge the generator system 10 to a depth such that the generator system 10 is resting on a floor of the moving body of water.

When operating, fluid from the moving body of water enters the inlet funnel 12. The fluid's kinetic energy is a product of its density, velocity, and an area through which the fluid flows. Specifically, kinetic energy is calculated as:

$$KE = \frac{1}{2} ρ A {v}^{3}$$

wherein KE is the kinetic energy of the fluid, ρ is the density, A is the cross-sectional area through which the fluid flows, and v is a velocity of the fluid. As the cross-sectional area of the inlet funnel 12 decreases, the velocity of the fluid increases before it reaches the plurality of generator units 14.

As the increased-velocity fluid contacts the turbine blades 24 of the one or more generator units 14 the turbine blades 24 rotate about the turbine hubs 26 which in turn generate electricity from the one or more generator units 14. Electricity from the one or more generator units 14 is transmitted to land through one or more transmission cables and distributed to a power grid.

The controller that is in communication with the plurality of ballast tanks 28 of the platform 16 and one or more gyroscopes 34 to maintain the generator system 10 at a desired depth and a substantially level position in the moving body of water. If the one or more gyroscopes 34 measure that the platform 16 has shifted away from a level position, the pumps 36 in communication with the one or more ballast tanks 28 force water into or out of the ballast tanks 28 to adjust buoyancy of the platform 16 and thereby maintain the platform in a level position.

The controller further may adjust a pitch of the turbine blades 24 based on an amount of electricity being produced by the generator units 14 and a rate of flow of the fluid entering the inlet funnel 12. The pitch of the turbine blades 24 of all of the turbine units may be varied based on a flow rate of the fluid entering the inlet funnel 12. Alternatively, the turbine blades 24 of each of the turbine units 14 may be varied independently for each generator unit 14 to maximize an amount of electricity generated by each generator unit 14. For example, it may be desirable to have a pitch angle that varies for generator units located adjacent walls of the inlet funnel 12 from generator units located adjacent a center portion of the inlet funnel 12.

The multi-turbine generator system 10 of the present disclosure advantageously converts fluid flowing in a moving body of water into electricity using the one or more generator units 14 in communication with the inlet funnel 12. Further, the multi-turbine generator system reduces any downtime that may occur as a result of one or more generator units failing because the generator units operate independent of one another. When replacement of a generator unit is required, the multi-turbine generator system may be raised to the surface of the body of water and the modular generator unit quickly replaced with an additional modular generator unit or removed for repair.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An underwater multi-turbine generator system comprising:
an inlet funnel including an inlet end and a narrower outlet end;
a plurality of generator units, each of the plurality of generator units including one or more turbine blades, wherein the turbine blades of the plurality of generator are substantially aligned adjacent the narrower outlet end of the inlet funnel; and
a platform for supporting the inlet funnel and plurality of generator units;
wherein the inlet funnel receives fluid from a moving body of water in the inlet end and directs the fluid to the turbine blades of the plurality of generator units adjacent the narrower outlet end of the inlet funnel.

2. The underwater multi-turbine generator system of claim 1 wherein the platform is comprises a plurality of ballast tanks for varying a depth of the underwater multi-turbine generator system.

3. The underwater multi-turbine generator system of claim 2 further comprising one or more gyroscopes, the one or more gyroscopes being in electrical communication with the plurality of ballast tanks for maintaining a position of the multi-turbine generator system.

4. The underwater multi-turbine generator system of claim 1, wherein the turbine blades of one or more of the plurality of turbine units are a first size and the turbine blades of one or more of the other plurality of turbines are a second and different size.

5. The underwater multi-turbine generator system of claim 1 wherein each of the plurality of generator units is substantially modular such that each of the plurality of generator units is removable independent of other generator units.

6. The underwater multi-turbine generator system of claim 1, wherein a pitch of the turbine blades of the plurality of generator units is adjustable.

7. An underwater multi-turbine generator system comprising:
an inlet funnel including an inlet end and a narrower outlet end;
a plurality of generator units, each of the plurality of generator units including one or more turbine blades, wherein the turbine blades of the plurality of generator are substantially aligned adjacent the narrower outlet end of the inlet funnel and wherein each of the plurality of generator units is substantially modular such that each of the plurality of generator units is removable independent of other generator units;
a platform for supporting the inlet funnel and plurality of generator units, wherein the platform is comprises a plurality of ballast tanks for varying a depth of the underwater multi-turbine generator system; and
one or more gyroscopes, the one or more gyroscopes being in electrical communication with the plurality of ballast tanks for maintaining a position of the multi-turbine generator system;
wherein the inlet funnel receives fluid from a moving body of water in the inlet end and directs the fluid to the turbine blades of the plurality of generator units adjacent the narrower outlet end of the inlet funnel.
